(19) United States
(12) Patent Application Publication
(10) Pub. No.: US 2005/0269018 A1
(43) Pub. Date: Dec. 8, 2005

(54) Heatable veneer element for motor vehicle steering wheels and process for producing such a veneer element

(75) Inventors: Christian Haart, Obernburg (DE); Holger Maul, Gross-Zimmern (DE); Martin Sauer, Hosbach (DE)

Correspondence Address: FITCH EVEN TABIN AND FLANNERY, 120 SOUTH LA SALLE STREET, SUITE 1600, CHICAGO, IL, 60603-3406, US

(73) Assignee: Takata-Petri AG

(21) Appl. No.: 11/138,082

(22) Filed: May 26, 2005

(30) Foreign Application Priority Data
May 28, 2004 (DE) 10 2004 027 008.2

(51) Int. Cl. B60L 1/02

(52) U.S. Cl. 156/196; 156/221; 156/245; 219/204

(57) ABSTRACT

A heatable veneer element for motor vehicle steering wheels and process for producing such a veneer element are disclosed. More particularly, a heatable veneer element for motor vehicle steering wheels is provided that includes a covering veneer piece having at least one layer of wood and/or imitation wood and a heating element which is joined inseparably to the covering veneer piece and serves to heat the covering veneer piece. The covering veneer piece is joined directly and inseparably to the heating element. This has the advantage that the distance which has to be traveled by the heat generated by means of the heating element is minimized and a short heating time (<3 min) of the ring of the steering wheel can thus be realized. The distance to be traveled corresponds essentially to the thickness of the covering veneer piece whose one or more layers can each be made very thin, i.e. <1 mm.

### RELATED APPLICATIONS

The original German patent application number 10 2004 027 008.2, filed May 28, 2004 is hereby expressly incorporated by reference

### DESCRIPTION

The invention relates to a heatable veneer element for motor vehicle steering wheels as set forth in claim 1. The invention further provides a process for producing such a veneer element.

Heatable veneer elements of this type serve, in particular, to enclose sections of the ring of a motor vehicle steering wheel. These veneer elements have a covering veneer piece comprising at least one layer of wood and/or imitation wood and a heating element joined inseparably to the covering veneer piece for heating the covering veneer piece.

Every heatable motor vehicle steering wheel usually has to meet the requirement that the ring of the steering wheel can, at least in sections, be brought quickly, i.e. in less than three minutes, to a temperature which feels pleasant. In the case of a wooden steering wheel, the comparatively poor thermal conductivity of wood stands in the way of this requirement.

Owing to this fundamental problem, EP 1 026 066 A2 proposes providing a thermally conductive base layer composed of plastic between the covering veneer piece and the heating element. The base layer proposed in that patent application is intended to provide, firstly, sufficient adhesion to the covering veneer layer applied on the outside; secondly, the desired short heating time of the surface of the ring of the steering wheel is said to be realized as a result of the good thermal conductivity of the base layer used, while achieving satisfactory mechanical strength of the overall veneer element.

However, this proposed solution has the disadvantage that a further, new material to increase the heating rate has to be provided in addition to the covering and core veneer layers usually present. As a result, the manufacturing process becomes more complicated and the production cost of such a veneer element is therefore inevitably increased.

It is therefore an object of the present invention to provide a heatable veneer element for motor vehicle steering wheels which overcomes the abovementioned difficulties and to provide a process by means of which such a veneer element can be produced economically and with industrially justifiable means.

This object is achieved by a veneer element having the features of claim 1 and by a production process as claimed in claim 16.

The invention provides for the covering veneer piece to be joined directly and inseparably to the heating element.

The feature of the “inseparable” bond between two elements means, for the purposes of the present patent application, that the two elements cannot be separated from one another without being destroyed. Such an inseparable bond is usually provided when laminating thin layers.

The feature of the “direct” bond between two elements means, for the purposes of the present patent application, that no further third element is present between the two elements. In the case of the structure according to the invention of the veneer element, this means that there is no further layer present between the heating element which generates the heat for heating and the at least one layer of wood or imitation wood of the covering veneer element, so that the heat generated does not have to pass through such a further layer on the way to the surface of the ring of the steering wheel. For the present purposes, the feature “imitation wood” refers to materials other than wood, in particular plastic, whose exterior has a wood grain appearance.

The direct bond defined above has the advantage that the distance which the heat for heating has to travel is minimized and thus a short heating time (<3 min) of the ring of the steering wheel can be realized. The distance which the heat has to travel corresponds essentially to the thickness of the covering veneer piece whose one or more layers can each be made very thin, i.e. <1 mm per layer. In addition, this desired action can be achieved without a specific heat conduction layer being necessary for this purpose.

In a preferred embodiment, the heating element has a heating layer and on its side facing away from the covering veneer piece is joined inseparably to a support piece. The support piece serves for mechanical stabilization and as means of fastening the thin laminate made up of covering veneer piece and heating element to the ring of the steering wheel.

In a further variant of the invention, the heating element has at least one lower core veneer layer adjoining the support piece. In this way, it becomes possible, in particular, to process thin heating layers which have previously been affixed to the core veneer in a simple manner in the production of the veneer element.

Furthermore, the support piece preferably has a mounting means comprising plastic and/or wood for mounting the veneer element on a motor vehicle steering wheel. The mounting means serve, in particular, to produce a clamping, snap, locking or welded connection between the veneer element and the ring of the steering wheel.

When the preferred thin covering veneer pieces are used, it is particularly advantageous to use a heating element having a coloration matched to the covering veneer piece. Particularly in the shaping of the covering veneer piece, it is probable that cracks will occur in it. A heating element having a color contrasting with that of the covering veneer piece would be visible and conspicuous through these cracks. The matched coloration of heating element and veneer piece therefore makes it possible for the overall aesthetic impression of the veneer piece to be maintained even in the case of the crack formation described.

In a preferred variant of the invention, the covering veneer piece is made up of two layers. It comprises a covering veneer layer on its side facing away from the heating element and, directly adjoining this covering veneer layer, an upper core veneer layer bound inseparably to the covering veneer layer. The use of a suitable core veneer makes it possible for the aesthetically attractive covering veneer layer to be laminated on with ideal adhesion properties.

When the heating element offers comparably good adhesion properties for the covering veneer layer, the covering veneer piece will preferably consist of a single decorative covering veneer layer.

The covering veneer layer is preferably provided with a thin, i.e. <1 mm thick, topcoat layer on its outward-facing side.

The heating layer of the heating element can be configured in a variety of ways, in particular as heating knitteds, woven heating fabrics, heating film or as nonwoven, in each case with printed-on or embedded electric heating conductors. Such a nonwoven can be composed of polyamide, polyester, polypropylene, sisal, cellulose or mixtures of these materials.

In a preferred embodiment, the resistance of the electric conductors and/or their spacing varies as a function of the position of the conductors on the heating layer. Defined regions having different heating times can be realized in this way.

The veneer element preferably has a shell-like structure so that the ring of a motor vehicle steering wheel can be surrounded in sections by the veneer element. Here, the veneer elements are configured as veneer shells so that the ring of the steering wheel can be enclosed completely by at least two veneer shells placed together. The veneer element has mechanical connecting means which interact on assembly of a plurality of veneer elements around a section of the ring of the steering wheel so that the abutting edges of the veneer elements form a very smooth transition. Such mechanical connecting means can be configured, in particular, as tongue-and-groove elements which are provided along the abutting edges of the veneer elements.

The configuration of the veneer elements in the form of half shells so that two veneer elements symmetrically surround the ring of the steering wheel along its half cross-sectional circumference is particularly advantageous.

The present invention also provides a process for producing a veneer element, which comprises the following steps. Firstly, a covering veneer piece which comprises at least one layer of wood and/or imitation wood and has been cut to size is provided. Adhesives are then provided on one side of the covering veneer piece provided and/or on one side of the heating element. The heating element is subsequently placed on the covering veneer piece and an inseparable bond between covering veneer piece and heating element is subsequently produced.

In one variant of the process of the invention, a shaping step for producing a permanent deformation of the covering veneer piece and of the heating element is carried out simultaneously with the process step of production of the inseparable bond (lamination). The veneer element is in this case brought with the aid of known lamination presses to the three-dimensional shape in which the veneer element is finally mounted on the ring of the motor vehicle steering wheel.

A second variant of the production process provides for both the covering veneer piece and the heating element to be subjected separately to a shaping step for producing a permanent deformation after the process step of provision of adhesives. Only subsequently is the process step of production of an inseparable bond between covering veneer piece and heating element carried out.

A third variant of the production process provides for both the covering veneer piece and the heating element to be subjected separately to a shaping step for producing a permanent deformation prior to the process step of provision of adhesives. The adhesives are then provided and the process step of production of an inseparable bond between covering veneer piece and heating element is subsequently carried out.

In all three process variants mentioned above, the heating element is preferably joined inseparably to a core veneer layer and/or a support piece. In this way, very thin heating elements can be processed in a simple manner together with likewise thin covering veneer pieces.

It is likewise conceivable for the covering veneer piece to be provided as an inseparable laminate of a covering veneer layer and an upper core veneer layer.

In a further variant of the production process, the veneer element is affixed to a support piece after the process step of production of an inseparable bond in a further process step. Alternatively, it is likewise possible for a plastic backing to be sprayed onto the veneer element after the process step for producing the inseparable bond, so as to form a support piece. Particularly inexpensive veneer elements can be produced in this way.

The adhesives applied to the covering veneer piece are in all process variants mentioned preferably configured as sized paper or as applied glue layer.

Further advantages and features of the invention will be explained in connection with the figures.

### BRIEF DESCRIPTION OF THE DRAWINGS

In the figures:

FIG. 1 shows a schematic layer structure of a section of the ring of a steering wheel with a veneer piece according to the invention in a perspective view;

FIG. 2a shows a cross-sectional view of the schematic layer structure of a first embodiment of a veneer piece according to the invention;

FIG. 2b shows a cross-sectional view as shown in FIG. 2a of a second embodiment;

FIG. 2c shows a cross-sectional view of a third embodiment;

FIG. 2d shows a cross-sectional view of a fourth embodiment;

FIG. 3 shows a plan view of a heating element with printed-on electric heating conductors;

FIG. 4a-4d schematically show the process steps of a first process for producing veneer elements;

FIG. 5a-5d shows a process as shown in FIG. 4a-4d in which a modified heating element is used;

FIG. 6a-6d schematically show the process steps of a second process for producing veneer elements;

FIG. 7a-7d show a process as shown in FIG. 6a-6d in which a modified heating element is used;

FIG. 8a-8d schematically show the process steps of a third process for producing veneer elements and

FIG. 9a-9d show a process as shown in FIG. 8a-8d in which a modified heating element is used.

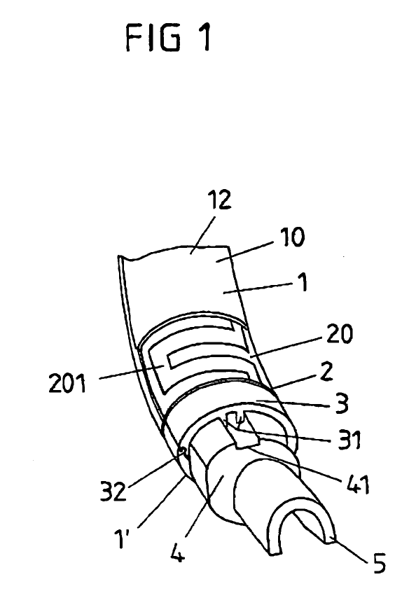

FIG. 1 shows a perspective view of a section of the ring of a steering wheel having two veneer elements according to the invention configured as half shells. The two veneer elements completely enclose the diameter of the ring of the steering wheel. The outermost layer of the two veneer elements is in each case formed by a covering veneer piece 1, 1′ with at least one layer of wood or imitation wood. Each covering veneer piece 1, 1′ comprises a completely external and therefore visible covering veneer layer 10 of a visually appealing wood or imitation wood. This gives the ring of the motor vehicle steering wheel the visual appearance of a wooden steering wheel.

To make the layer structure of the steering wheel clearer, this is shown in perspective going out from the interior skeleton 5 of the ring of the steering wheel. The skeleton 5 of the ring of the steering wheel is clad with a coating of polymer foam 4, preferably polyurethane or expandable polypropylene. This polymer foam 4 serves, in a known manner, to absorb kinetic impact energy of the motor vehicle driver by deformation in the case of a crash. The skeleton 5 of the ring of the steering wheel and the polymer foam 4 surrounding this thus form the base steering wheel ring. Holding structures 41 can be molded into the polymer foam 4 of this base steering wheel ring, as shown in FIG. 1, and these interact with corresponding mounting means 31 of the veneer elements surrounding the base steering wheel ring in order to fix the veneer elements to the base steering wheel ring. In FIG. 1, the holding structures 41 are configured as grooves running round the base steering wheel ring. The mounting means 31 of the veneer elements in the form of a tongue device project into these grooves 41, so that veneer element and base steering wheel ring are joined to one another in this example by means of a tongue-and-groove joint 31, 41.

It goes without saying that alternative holding structures 41 customary in the art can interact with corresponding mounting means 31. In each case, it is important that the veneer elements are secured against rotation around and/or slippage along the base steering wheel ring.

In FIG. 1, only the upper circumferential groove 41 for fixing the upper veneer element can be seen because of the perspective view. The lower holding structure 41 is configured essentially as the mirror image of the same groove form or another form of holding structures 41 is provided for the lower veneer element. In the case of the latter variant, it is possible for the three-dimensional arrangement of the individual veneer elements along the ring of the steering wheel to be determined by the different configuration of the holding structures 41. In the mounting of the veneer elements, mounting in an incorrect position along the ring of the steering wheel is avoided in this way.

The mounting means 31 are constructed in one piece with the support piece 3 of the veneer element. The one-piece construction can be achieved particularly simply by the support piece 3 being provided in the form of an injection-molded plastic part. The preshaped and laminated unit of covering veneer piece 1 and heating element 2 can for this purpose be backsprayed with a polymer to form the support piece 3 directly. However, it is likewise conceivable for a support piece 3 of wood to be provided and the preshaped and laminated unit of covering veneer piece 1 and heating element 2 to be mounted thereon or covering veneer piece 1, heating element 2 and support piece 3 to be laminated in one process step.

The sheet-like heating element 2 having a meandering electric heating conductor 201 can be seen on the support piece 3. This heating element 2 can, for example, be formed by a heating layer 20 comprising a film or a nonwoven onto which the electric heating conductors 201 are printed in the desired geometry. The heating element 2 with its heating layer 20 serves to heat the covering veneer piece 1 which comprises at least one layer of wood and/or imitation wood and is located above it. The covering veneer piece 1 has an externally visible covering veneer layer 10 which gives the optically aesthetic “wood impression” of the ring of the steering wheel. This covering veneer layer 10 is coated with a thin, usually transparent topcoat layer 12. This topcoat layer 12 is usually thin, i.e. has a thickness of <1 mm. However, it is also conceivable for the topcoat layer 12 to be thicker than 1 mm, particularly when the thermal conduction properties of the topcoat are good.

The two veneer elements configured as half shells in relation to the base steering wheel ring completely enclose the base steering wheel ring. To ensure a very smooth transition between the externally positioned covering veneer layers 10 at the abutting edges of the veneer elements, mechanical connecting means 32 are provided along these edges. In FIG. 1, these are configured as a tongue-and-groove joint.

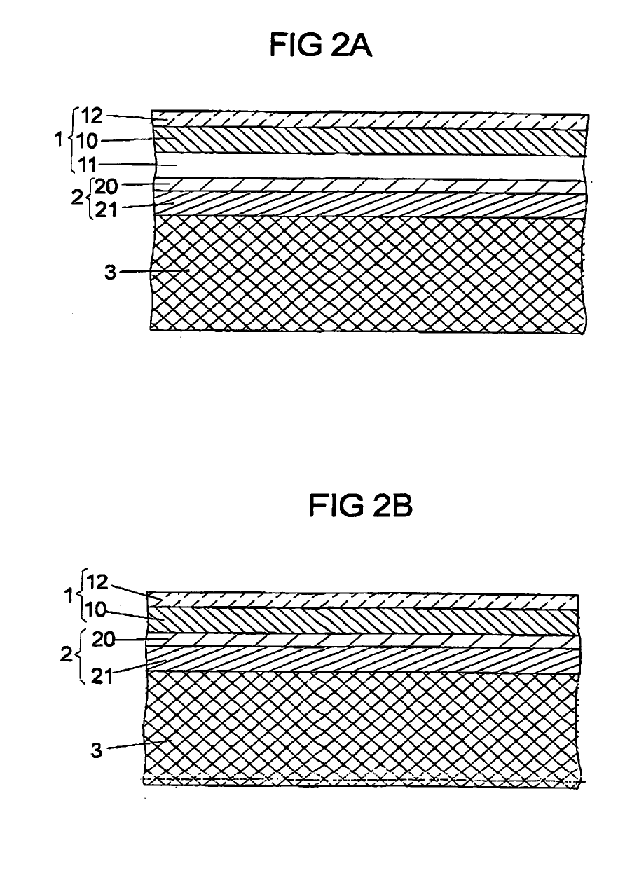

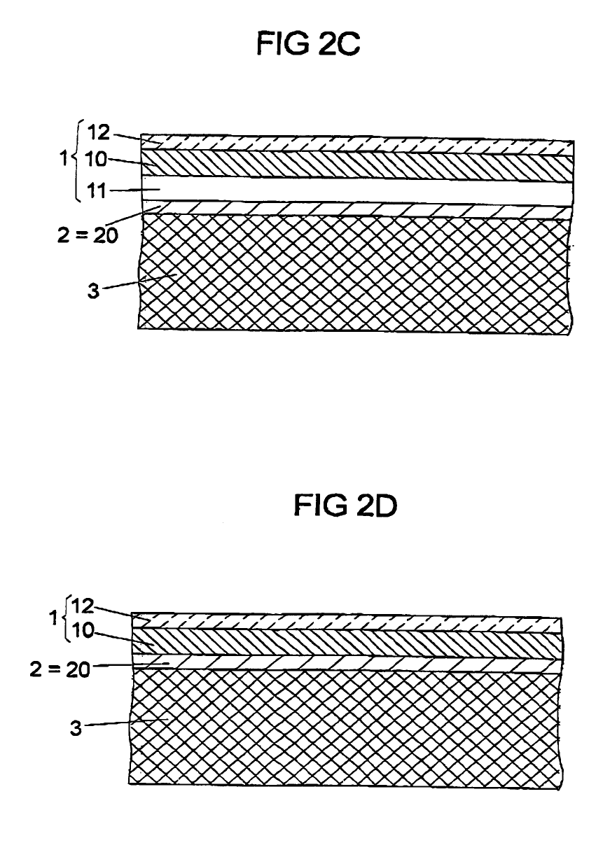

FIGS. 2a to 2d show details of various embodiments of the veneer element according to the invention comprising a covering veneer piece 1, a heating element 2 and a support piece 3.

In the first embodiment shown in FIG. 2a, the heating layer 20 of the heating element 2 is surrounded symmetrically by a lower core veneer layer 21 and an upper core veneer layer 11. The terms “below” and “top” always refer in the following to the orientation such that the external, visible covering veneer layer 10 is located at the “top”. The symmetrical structure shown in FIG. 2a ensures that when an inseparable bond between heating element 2 and covering veneer piece 1 is established, which is usually associated with its deformation to produce a shell-like shape, mechanical distortion of the veneer shell which has been laminated on in this way is prevented.

However, it is likewise conceivable, as shown in FIG. 2b, for the covering veneer piece 1 comprising a single covering veneer layer 10 to be laminated directly without core veneer onto the heating layer 20 of the heating element 2. Otherwise, the structure shown in FIG. 2b corresponds to that of FIG. 2a.

FIG. 2c shows a further “asymmetric” layer structure. In this embodiment, the heating element 2 comprises only the heating layer 20 without a lower core veneer being present on the side facing away from the covering veneer piece 1. Otherwise, the structure shown in FIG. 2c corresponds to that of FIG. 2a.

Finally, FIG. 2d shows a further embodiment of the veneer element having a symmetrical layer structure. Here, the use of core veneers is omitted entirely, so that the covering veneer piece 1 consists of a single covering veneer layer 10 and the heating element 2 consists of a single heating layer 20.

In all four of the layer structures presented by way of example, the covering veneer layer 10 has a topcoat layer 12 on its upper side. This topcoat layer 12 is usually less than 1 mm thick.

Which of the four embodiments presented above is to be selected in a particular case depends in particular on the material properties and thicknesses of the covering veneer layer 10 and the heating layer 20. However, the distance between the heating layer 20 and the surface of the topcoat layer 12 facing away from it on the covering veneer layer 10 is in all embodiments significantly less than 3 mm. This distance has to be penetrated by the heat generated by the heating layer 20 of the heating element 2 in order to reach the surface of the covering veneer layer 10 which is contacted by the vehicle driver. As a result of a wood (laminate) layer having a thickness of less than 3 mm having to be “heated through”, rapid heating (<3 min) of the surface of the covering veneer layer 10 on the veneer element can be ensured despite the poor thermal conductivity properties of wood.

It is usual to employ both covering and core veneer layers having a thickness of about 0.6 mm. During lamination and deformation of the covering veneer piece 1 together with the heating element 2, cracks are usually formed in the covering veneer piece 1 because of the thin veneers. If the heating layer 20 has a coloration matched to the covering veneer piece 1, significant impairment of the visual appearance of the covering veneer layer 10 is prevented in this simple way as a result of the matched coloration. The cracks formed themselves are filled by the topcoat 12 on coating of the covering veneer layer 10, so that the feel of the covering veneer layer 10 is not obviously affected despite the presence of cracks.

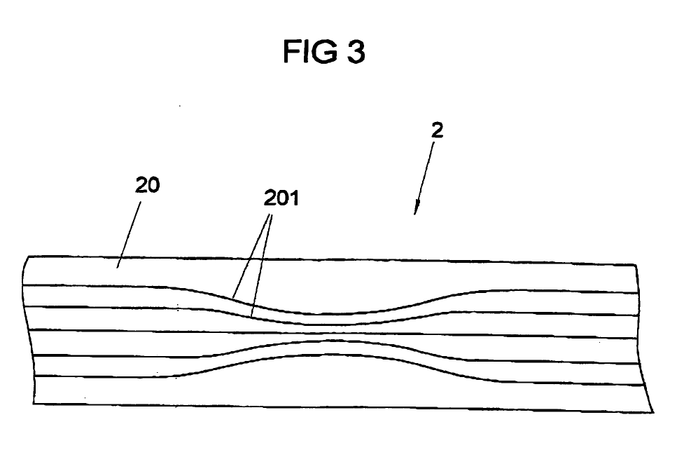

FIG. 3 shows by way of example a plan view of a heating layer 20 with electric heating conductors 201. The heating layer 20 can, for example, be formed by a suitable nonwoven or a film, with the electric heating conductors 201 being printed in the desired geometry onto the heating layer 20. It is likewise conceivable for the heating conductors 201 to be embedded in and surrounded by layers of nonwoven.

As a result of the conductors 201 being physically closer to one another in particular regions, it is ensured that the heating time of the covering veneer piece 1 is particularly short in these regions.

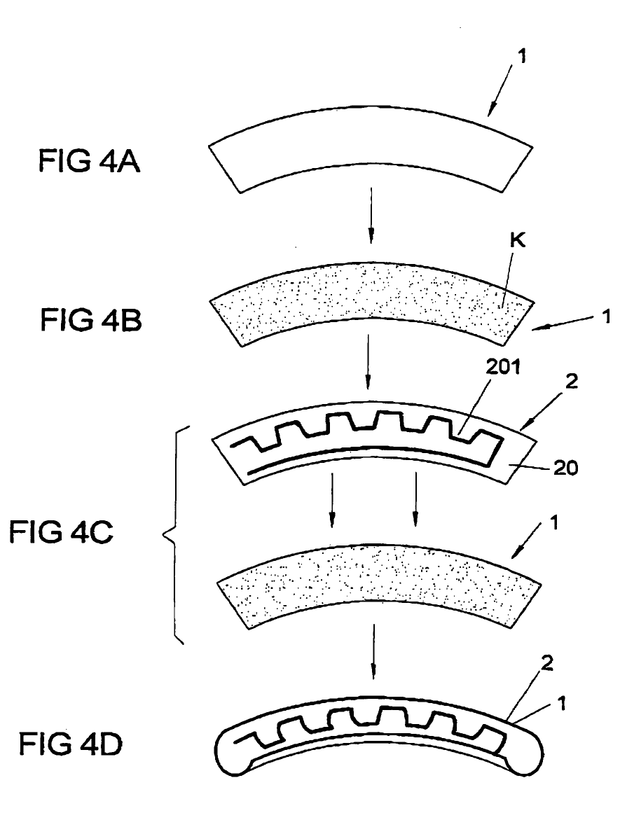

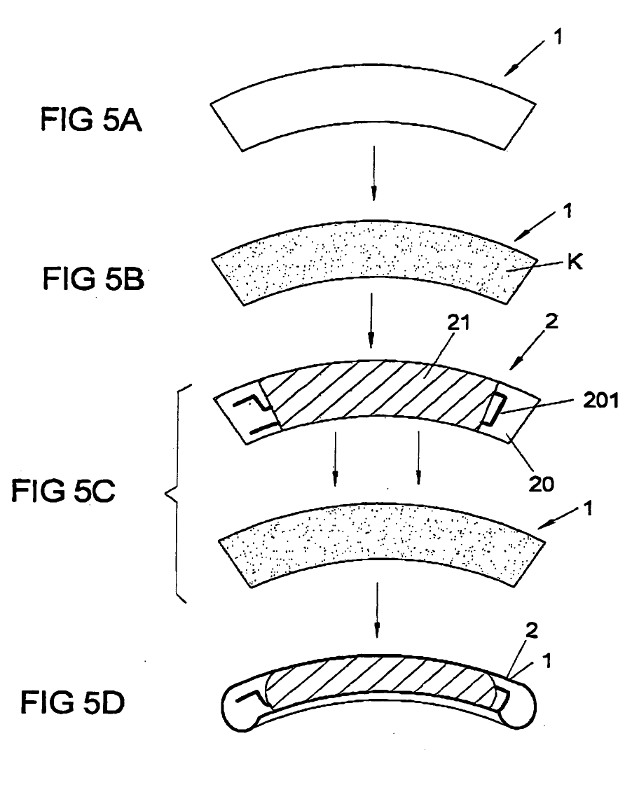

In the following two process variants as shown in FIGS. 4a to 4d and 5a to 5d for producing the veneer elements of the invention are described.

In the first process step of FIG. 4a, a covering veneer piece 1 is provided. This covering veneer piece 1 consists, for example, of a single covering veneer layer 10 (cf. FIG. 2b) or a laminate of a covering veneer layer 10 with a core veneer layer 11 (cf. FIG. 2a). In the process step shown in FIG. 4b, a surface of the covering veneer piece 1 provided and/or the underside which is not visible of the heating element shown in FIG. 4c is provided with an adhesive K. This adhesive K is usually employed in the form of a glue applied in liquid form or a sized paper which has been cut to the appropriate shape.

FIG. 4c shows the lamination of the covering veneer piece 1 with the heating element 2, as a result of which an inseparable bond is achieved. In this embodiment of the production process, the heating element 2 consists exclusively of a heating layer 20 with electric heating conductors 201 located thereon (cf. FIG. 2c or 2d). The process step of production of an inseparable bond (lamination) between covering veneer piece 1 and heating element 2 shown in FIG. 4c is associated in this first variant of the production process with permanent deformation of this laminate to produce a shell-like veneer element. The result of this process step is shown by way of example in FIG. 4d.

In a last process step which is not shown, the covering veneer layer 10 is coated on the surface of the covering veneer piece 1 with a thin, i.e. <1 mm, topcoat layer 12.

The production process shown in FIGS. 5a to 5d corresponds to the first variant described above, except that the heating element 2 comprises not only a heating layer 20 with electric heating conductors 201 provided thereon but also a lower core veneer 21 laminated onto it (cf. FIG. 2a).

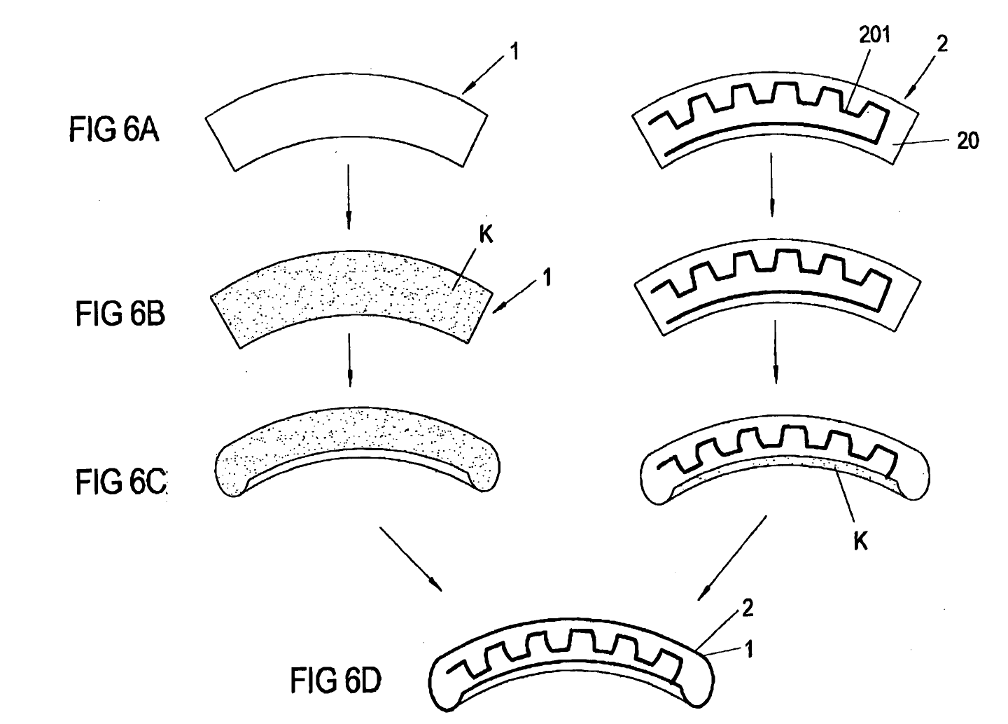

FIGS. 6a to 6d show a second variant of the production process of the invention. The provision of the covering veneer piece 1 and the heating element 2 and the provision of adhesives K shown in FIGS. 6a and 6b corresponds to the above-described process steps of FIGS. 4a and 4b. As a difference from the first production process, the covering veneer piece 1 and the heating element 2 are subjected separately to a shaping step to produce a permanent deformation before production of the inseparable bond. This is shown schematically in FIG. 6c. Only then are covering veneer piece 1 and heating element 2 laminated together. The result as shown in FIG. 6d corresponds to the process result shown in FIG. 4d.

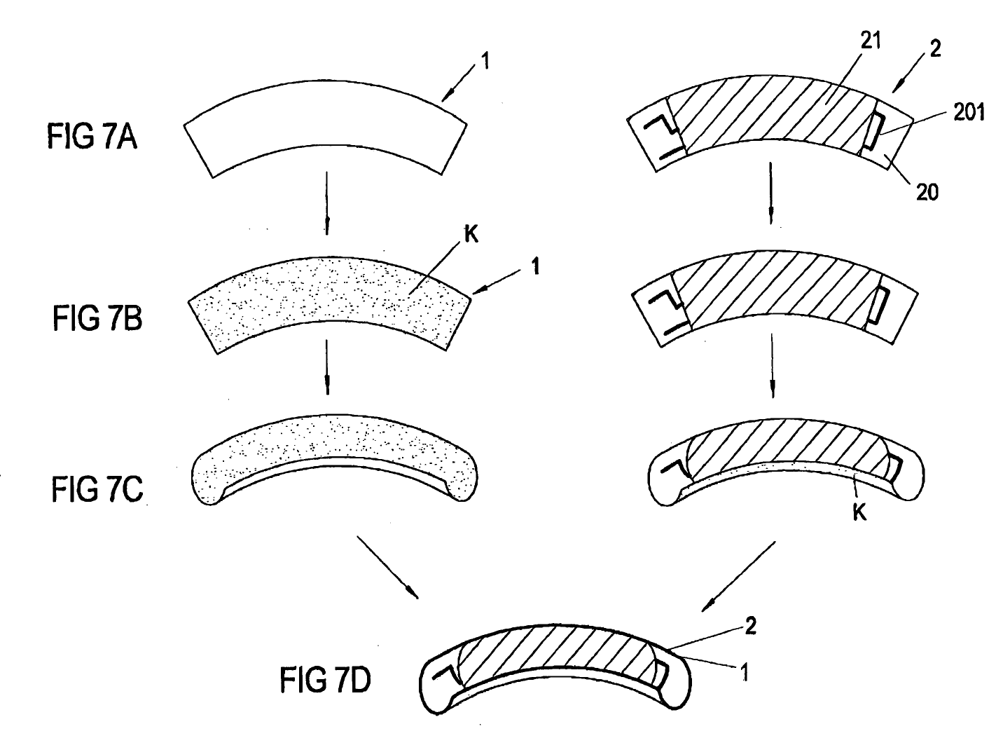

The production process shown in FIGS. 7a to 7d corresponds to that of FIGS. 6a to 6d, with the only difference being that a heating element 2 with a core veneer layer 21 is employed. The process product shown in FIG. 7d corresponds to that of FIG. 5d.

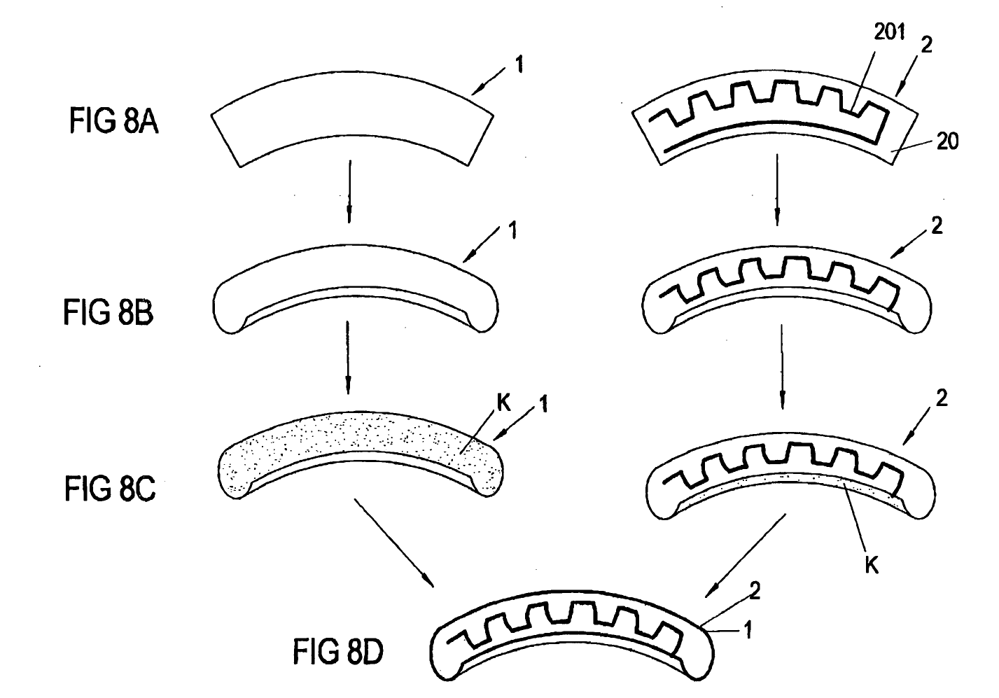

FIGS. 8a to 8d show a third variant of the production process of the invention. The provision of the covering veneer piece 1 and the heating element 2 shown in FIG. 8a corresponds to the above-described process step of FIGS. 4a and 6a. However, as a difference from the second production process, the covering veneer piece 1 and the heating element 2 are subjected separately to a shaping step to produce a permanent deformation prior to the process step of provision of adhesives K. This is shown schematically in FIG. 8b. Covering veneer piece 1 and/or heating element 2 are subsequently provided with adhesives K (FIG. 8c) and finally laminated (FIG. 8c). The result shown in FIG. 8d corresponds to the process result shown in FIGS. 4d and 6d.

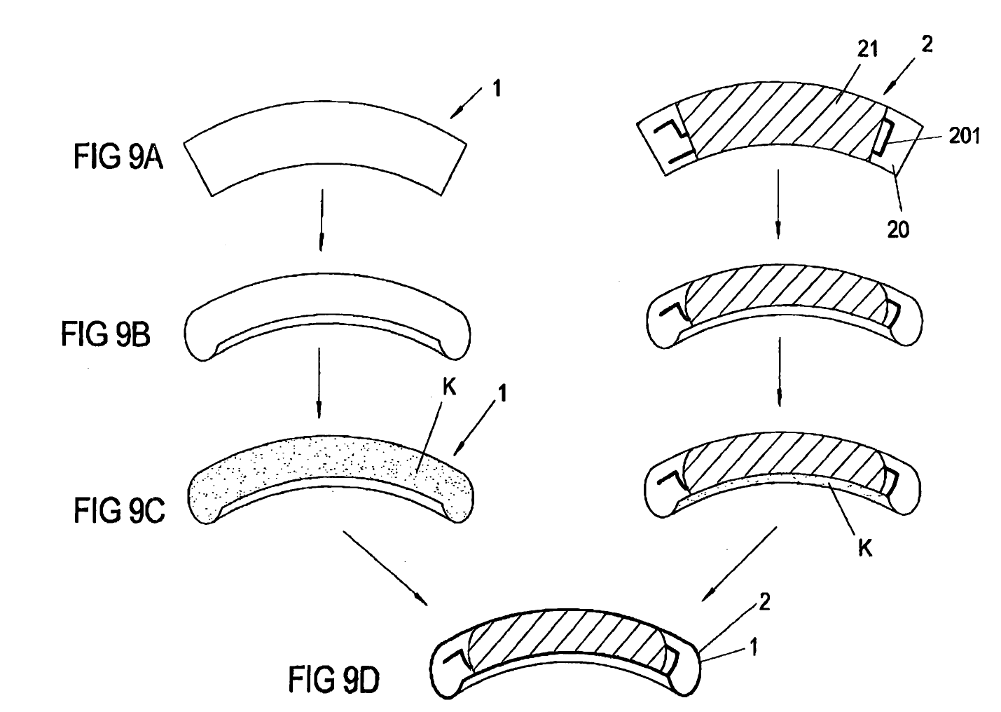

The production process shown in FIGS. 9a to 9d corresponds to that of FIGS. 8a to 8d, with the only difference being that a heating element 2 with a core veneer layer 21 is employed. The process product shown in FIG. 9d corresponds to that of FIG. 7d or FIG. 5d.

In all three variants of the production process of the invention, a process step which is not shown for applying the topcoat layer 12 to the covering veneer layer 10 of the covering veneer piece 1 follows in each case.

1. A heatable veneer element for motor vehicle steering wheels comprising:
a covering veneer piece comprising at least one layer of wood and/or imitation wood; and
a heating element which is joined inseparably to the covering veneer piece and serves to heat the covering veneer piece, wherein the covering veneer piece is joined directly and inseparably to the heating element.

2. The veneer element as claimed in claim 1, wherein the heating element comprises a heating layer and on its side facing away from the covering veneer piece is joined inseparably to a support piece.

3. The veneer element as claimed in claim 2, wherein the heating element has at least one lower core veneer layer adjoining the support piece.

4. The veneer element as claimed in claim 2, wherein the support piece has a mounting means comprising plastic and/or wood for mounting the veneer element on a motor vehicle steering wheel.

5. The veneer element as claimed in claim 1, wherein the heating element has a coloration matched to the covering veneer piece.

6. The veneer element as claimed in claim 1, wherein the covering veneer piece comprises a covering veneer layer on its side facing away from the heating element and an upper core veneer layer joined inseparably to the covering veneer layer on its other side.

7. The veneer element as claimed in claims 1, wherein the covering veneer piece consists of a single layer configured as covering veneer layer.

8. The veneer element as claimed in claim 7, wherein the covering veneer layer is provided with a topcoat layer on its side facing away from the heating element.

9. The veneer element as claimed in claim 1, wherein the heating layer of the heating element is configured as heating knitteds, woven heating fabrics, heating film or as nonwoven, in each case with printed-on or embedded electric heating conductors.

10. The veneer element as claimed in claim 9, wherein the resistance of the electric conductors and/or their spacing vary.

11. The veneer element as claimed in claim 1, wherein the veneer element has a shell-like structure so that the ring of a motor vehicle steering wheel can be surrounded in sections by the veneer element.

12. The veneer element as claimed in claim 1, wherein the veneer element has mechanical connecting means which interact on assembly of a plurality of veneer elements around a section of the ring of the steering wheel.

13. The veneer element as claimed in claim 12, wherein the mechanical connecting means are configured as tongue-and-groove elements.

14. The veneer element as claimed in claim 11, wherein the veneer element is configured in the form of a half shell so that it surrounds the ring of the steering wheel along its half cross-sectional circumference.

15. The veneer element as claimed in claim 1 in combination with the steering wheel.

16. A process for producing a veneer element, the process comprising:
providing a covering veneer piece which comprises at least one layer of wood and/or imitation wood and has been cut to size;
providing adhesives on one side of the covering veneer piece and/or on one side of a heating element;
placing the heating element on the side of the covering veneer piece which has been provided with adhesives; and
producing an inseparable bond between covering veneer piece and heating element.

17. The process as claimed in claim 16, wherein a shaping step for producing a permanent deformation of the covering veneer piece and of the heating element is carried out simultaneously with the process step of producing the inseparable bond.

18. The process as claimed in claim 16, wherein both the covering veneer piece and the heating element are subjected to a shaping step for producing a permanent deformation after the process step of providing adhesives.

19. The process as claimed in claim 16, wherein both the covering veneer piece and the heating element are subjected to a shaping step for producing a permanent deformation prior to the process step of providing adhesives.

20. The process as claimed in claim 16, wherein the heating element is provided in a form which is inseparably joined to a core veneer layer or a support piece.

21. The process as claimed in claims 16, wherein the covering veneer piece is provided as an inseparable laminate of a covering veneer layer and an upper core veneer layer.

22. The process as claimed in any of claim 21, wherein the veneer element is affixed to a support piece after the process step of producing an inseparable bond.

23. The process as claimed in claim 16, wherein a plastic backing is sprayed onto the veneer element after the process step of producing the inseparable bond, so as to form a support piece.

24. The process as claimed in claim 16, wherein the adhesives are configured as sized paper or as applied glue layer.

25. The process as claimed in claims 16, wherein the covering veneer piece is provided in a surface coating step with a topcoat layer on its side facing away from the heating element.
